(19) United States
(12) Patent Application Publication
(10) Pub. No.: US 2016/0208166 A1
(43) Pub. Date: Jul. 21, 2016

(54) COMPOSITION USED FOR THE TREATMENT OF SOILS

(71) Applicant: Peter Good, Brunnen (CH)

(72) Inventor: Peter Good, Brunnen (CH)

(21) Appl. No.: 14/980,582

(22) Filed: Dec. 28, 2015

(30) Foreign Application Priority Data
Jan. 20, 2015 (EP) 15000147.7

(51) Int. Cl. C09K 17/36

(52) U.S. Cl. CPC C09K 17/36

(57) ABSTRACT

The present invention concerns a composition for the treatment of soils containing a mixture of sodium or potassium methylsiliconate, of xanthan and of PEG or polysorbate diluted in water.

### CROSS REFERENCE TO RELATED APPLICATIONS

The present application claims priority to European Patent Application No. 15000147.7, filed Jan. 20, 2015, the entire contents of which are being incorporated herein by reference.

### BACKGROUND

The present invention concerns a composition used for the treatment of soils.

It is already known to treat soils with a composition based on sodium or potassium methylsiliconate, that means the composition object of the patent EP 889′109. The objective in this case is to dispose of a composition to obtain a substrate which is water-repellent, like a soil, to avoid the evaporation of the water. After this soil has been treated with this composition, the polimerisation of the active principle allows a development of a water-repellent characteristic, decreasing therefore the evaporation of the water in the substrate. The problem with this composition is that it leads to a good water-repellency, but it necessitates a high concentration in methylsiliconate. The consequence on one part is that it leads to increase the cost of the treatment and on the other part it necessitates from the farmer to spray a high volume of water on the substrate to be treated.

### SUMMARY

The objective of the present invention is to dispose of a composition, which is water-repellent, with a less high quantity of methylsiliconate and with a lower volume of water to be sprayed on the soil. This composition furthermore allows to regulate the growth of weeds by maintaining a higher yield of the planted seeds. On the other part, the regulation of the growth of the weeds is also possible with an application of the same product at high concentration. On the other side, the product according to the invention can also replace plastic covers, which are used for the culture of salads, tomatoes,—and others and which have been submitted to a fumigation with commercial products like sodium-metam and others.

### DETAILED DESCRIPTION

The present invention concerns a composition used for the treatment of soils containing a mixture of sodium or potassium alkylsiliconate, of polysaccharide and of polyethylenglycol or polysorbate diluted in water.

Preferably, the alkylsiliconate used is a methylsiliconate. By polysaccharide, we understand arabic gum, karaya gum, an alginate or xanthan. Preferably used according to the invention is xanthan.

Every type of polythylenglycol (PEG) can be used. Preferably, PEG having a molecular weight comprised between 200 and 4000 or polysorbate known under the brand TWEEN 20-80 is used. The function of PEG or polysorbate is to increase the wettability of the polysaccharide.

The composition according to the invention allows to treat any type of soil, for example a muddy, clayey or sandy soil. It is also possible to treat gravel and compost. It is clear that depending on the type of soil treated, the concentration of metylsiliconate, of xanthan and of PEG or polysorbate will be different.

The type of methylsiliconate is not critical according to the invention. Preferably, potassium methylsiliconate is used. This composition contains, in weight, between 0.1 and 1.5% of methylsiliconate. Preferably, the composition contains between 0.15 and 1.1% of methylsiliconate. The methylsiliconate is from Wacker Chemie GmbH or from Dow Corning SA. In the case of Wacker, the metylsiliconate is in the form of solution containing 34% of methylsiliconate. In the case of Dow Corning SA, the solution contains 40% of methylsiliconate.

The content of xanthan in the composition is comprised in weight between 0.02 and 0.3%. Preferably, the content is comprised between 0.05 and 0.2%. In the present specification, all the quantities are in weight.

The content in polyethylenglycol in the composition is comprised between 0.04 and 0.6%. The content is preferably comprised between 0.10 and 0.4%.

A very satisfying result is obtained for decreasing the growth of the weeds with a concentration of methylsiliconate of 0.9%, a concentration of xanthan of 0.2% and of PEG 400 of 0.4%.

The composition of the invention can also contain an indicating agent depicting permanently the efficiency of the preparation by the use of specific sensitive colouring agents at a concentration of 0.1-0.3 ppm, preferably at a concentration of 0.2 ppm.

The present invention concerns further a process for the treatment of soils, wherein a composition as mentioned above is applied in a quantity comprised between 1000 and 7000 l per hectare. Preferably, the composition is applied in a quantiy comprised between 3000 and 7000 l per hectare. The treatment on the soil is carried out at ambient temperature independent of the geographic place of the treatment.

The application on the soil is carried out by a previous scratching, followed by a spraying of the composition of the invention. The type of the spraying apparatus is not critical and can be any known apparatus normally used by the man skilled in the art. It is also possible to proceed by watering.

The treatment according to the invention allows to decrease the frequency of watering by a factor of 2.

It is possible according to the invention, as mentioned above, to treat as well a muddy, clayey and sandy soil. Depending on the treated soil, it is preferred to treat on a more or less thickness, for example on a thickness comprised between 0.5 and 0.6 mm.

According to the invention, it is possible to consider the harvest of any type of farm product. The vegetables are particularly well considered, like the salads, the tomatoes, the carrots, the spinachs, the potatoes, the onions, the celeries, the ocras, the cucumbers, the artichauds. As a rule, the C3 plants, which are more sensitive to the water stress are preferred for the treatment with the composition according to the invention. Furthermore, the long lasting cultures and the fruits (Strawberry, melons and others) are also well considered for the treatment with the composition according to the invention.

The invention concerns further the use of the composition according to the invention for a fumigation process. The type of fumigation is not critical: the metam-sodium fumigation is preferred. The process consists of treating with the composition according to the invention and to proceed after with the fumigation process. The known objective of this fumigation is corresponding with a pesticide, weed-killer and fungicide treatment.

It has been noticed that this treatment allows a significant increase of the weight of the harvested vegetables.

The following specification is done in reference with the examples.

### EXAMPLE 1

### Test Without Culture Under Greenhouse for Testing the Evaporation.

A sandy field of 17.5 m2 has been treated under greenhouse with a solution of 40 l per ha of methylsiliconate (Wacker solution at 34%), 3 kg per ha of xanthan, 6 kg per ha of PEG 400, diluted at 5000 l per ha with water. The second field of 17.5 m2 and of same composition has not been treated. Both fields were saturated with water before the treatment by spraying. Two tensiometers were placed on each field at depths of 20 and 40 cm. The evaporation of the water in the field without treatment started immediately whereas the evaporation in the treated field started only after 5 days as indicated by the tensiometers placed on both depths of 20 and 40 cm respectively. After 12 days of measure, the evaporation at a depth of 40 cm in the field without treatment with double compared with the field with treatment. The evaporation at a depth of 20 cm was 35% less compared with the non treated reference.

### EXAMPLE 2

### Test Without Culture Under Greenhouse for Testing the Evaporation.

The same test as in example 1 has been carried out in the same conditions under greenhouse compared with a field of 17.5 m2 which was treated with a solution of 40 l per ha of methylsiliconate, 3 kg per ha of xanthan and 6 kg per ha of polysorbate (Tween 20), diluted with water at 5000 l per ha. Both tensiometers were placed in the middle of the field like for example 1 at depths of 20 and 40 cm. The evaporation of the non treated field started immediately, but the evaporation of the treated field started only after 4 days at the depth of 40 cm and after 2 days at the depth of 20 cm. After 12 days of measure, the evaporation at the depth of 40 cm was 25% less than the evaporation of the reference at the same depth and the evaporation at the depth of 20 cm was 20% less compared with the reference at the same depth.

### EXAMPLE 3

### Test with Culture of Tomatoes and Reduction of 14% of Irrigation.

A field of 7300 m2 with a sandy soil of a farm specialised in tomatoes was treated with a solution of 5000 l/ha of water containing 40 l/ha of methylsiliconate, 3 kg/ha of xanthan and 6 kg/ha of PEG 400, which was prepared just before the spraying. The solution was applied with a tractor equipped with nozzles which are normally used for the chemical treatment in the farm. The tomatoes were planted two weeks before the treatment to well develop the roots. The field was equipped with an underground drip irrigation system placed at a depth of 30 to 35 cm. The field was also equipped with a tensiometers station of two probes. The irrigation with water was reduced of 14-15% during the time of culture compared with the reference (normal culture of the farm). The harvest was done after 120 days and the yield was identical in tonnage of tomatoes with the reference (same surface with identical tomatoes without treatment). The graphs of the tensiometers at 30 cm depth show a constant humidity during the cycle around the roots during the phases of irrigation.

### EXAMPLE 4

### Test with Culture of Tomatoes and Reduction of 28% of Irrigation.

A field with the same dimension and the same composition as under example 3 was treated with the same equipment and solution as under example 3 with identical tomatoes, planted 2 weeks before. The filed was also equipped with a station of tensiometers with 2 probes. The irrigation with water was reduced of 28% during the time of culture compared with the reference. The harvest after 120 days showed a yield which was only a couple of % below the reference in the same conditions. The graphs of the tensiometers showed also a constant humidity during the whole cycle of 120 days during the irrigation phases.

### EXAMPLE 5

### Test Under Greenhouse to Avoid or Limit the Growth of Weeds.

Six terrines of 0.24 m2 of surface with non-limesrone sand (<500 micrometers) with 5% of water were prepared, seeded with 1 g amaranth seeds and treated with solutions, which correspond to

1) 40 l/ha of methylsiliconate and 1 kg/ha of xanthan;

2) 80 l/ha of methylsiliconate and 2 kg/ha of xanthan;

3) 40 l/ha of methylsiliconate and 3 kg/ha of xanthan;

4) 60 l/ha of methylsiliconate and 6 kg/ha of xanthan;

5) 120 l/ha of methylsiliconate and 12 kg/ha of xanthan;

6) One terrine without treatment as reference.

The polyethylenglycol 400 used was always with double concentration of xanthan, the dilution corresponds to 5000 l/ha.

The terrines were dried at 40° C. during 2 hours (etuve) and stored during 10 days in a greenhouse heated at 22-28° C.

The results were the following:

For the test 1, the reduction of weeds was 52% compared with the reference. For the test 2, the reduction was 68%. For the test 3, it was of 60%. For the test 4, the reduction was 47% and for the last test, it was of 84%.

### EXAMPLE 6

### Test for Replacing the Plastic Covers for the Culture Which Have Been Submitted to a Fumigation.

A field of 1260 m2 equipped with a nozzle system of irrigation was treated with a solution of 5000 l/ha of water containing 40 l/ha of methylsiliconate, 3 kg/ha of xanthan and 6 kg/ha of PEG. The treatment with metam-sodium was added to the irrigation water. In a reference field, plastic covers were used (usual treatment).

After one week, the plastic covers in the reference field were removed and the salads were planted in the 2 zones. The irrigation was identical for the two fields. The harvest was carried out after 7 weeks as usually and the result showed that the salads of the zone treated with the product according to the invention were 20% bigger than those of the non treated zone.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

1. Composition used for the treatment of soils containing a mixture of sodium or potassium methylsiliconate, of xanthan and of PEG or polysorbate diluted in water.

2. Composition according to claim 1, wherein it contains between 0.1 and 1.5% in weight of methylsiliconate.

3. Composition according to claim 1, wherein it contains between 0.02 and 0.3% in weight of xanthan.

4. Composition according to claim 1, wherein it contains between 0.04 and 0.6% in weight of PEG or polysorbate.

5. A process of treatment of soils, wherein a composition used for the treatment of soils containing a mixture of sodium or potassium methylsiliconate, of xanthan and of PEG or polysorbate diluted in water is applied in a quantity comprised between 1000 and 7000 1 per ha to soil.

6. Composition according to claim 1, wherein it is applied on a muddy, clayey or sandy soil.

7. Composition according to claim 1, wherein it contains 0.9% in weight of methylsiliconate, 0.2% in weight of xanthan and 0.4% in weight of Polyethylenglycol or polysorbate for reducing the growth of weeds up to 82%.

8. A method for fumigation comprising the step of applying a composition used for the treatment of soils containing a mixture of sodium or potassium methylsiliconate, of xanthan and of PEG or polysorbate diluted in water to an object to be fumigated.
